(19) United States
(12) Patent Application Publication
(10) Pub. No.: US 2025/0217483 A1
(43) Pub. Date: Jul. 3, 2025

(54) System and Method For Eliminating Ransomware Infections on Network Shares

(71) Applicant: NuRD LLC, Bloomfield, NJ (US)

(72) Inventors: Mehmet Ozer Metin, Livingston, NJ (US); Oleg Kalinin, Odessa (UA); Vasily Plotnikov, Odessa (UA)

(21) Appl. No.: 19/002,654

(22) Filed: Dec. 26, 2024

Related U.S. Application Data
(60) Provisional application No. 63/615,471, filed on Dec. 28, 2023.

(51) Int. Cl. G06F 21/55; G06F 21/56

(52) U.S. Cl. CPC G06F 21/554; G06F 21/566

(57) ABSTRACT

There is provided a system and method for eliminating ransomware infections on network shares. The system and method determines if a file on a shared network drive is written to, then the system buffers the data into memory and does not allow writing to the disk. After buffering, it sends this data for verification in user mode through a system service to an antivirus engine crypto-locker scanner. The anti-virus engine makes a verdict and if it does not detect encryption, then the data is recorded. If encryption was detected, the recording is blocked and localized to prevent spreading across a network.

### CROSS REFERENCE TO RELATED APPLICATIONS

This application claims the benefit of and priority to U.S. Provisional Patent Application Ser. No. 63/615,471 filed on Dec. 28, 2023 and incorporated herein by reference in its entirety.

### FIELD OF THE INVENTION

The invention relates to the field of cybersecurity, and more particularly to protecting against ransomware infections.

### BACKGROUND OF THE INVENTION

Ransomware encrypting files on network drives, even when only one endpoint is infected, is a significant cybersecurity threat. This capability stems from how modern networks and operating systems are designed, as well as the sophisticated nature of ransomware. Here's a detailed explanation of how this process typically unfolds.

Initial Infection: The ransomware first infects a single endpoint. This can happen through various means such as a phishing email, malicious website, or exploiting a vulnerability in an application or the operating system. The user may unknowingly trigger this infection by opening an infected email attachment or clicking on a malicious link.

Elevation of Privileges: After infecting the endpoint, ransomware often attempts to gain higher system privileges. It may exploit system vulnerabilities or use techniques like credential dumping to obtain administrative rights. Elevated privileges are crucial for the next steps, as they allow the ransomware to perform actions that would normally be restricted.

Network Discovery: With elevated privileges, the ransomware can execute scripts or use built-in network discovery tools to identify other machines and network resources connected to the infected endpoint. This includes mapping network drives, shared folders, and storage devices accessible from the infected machine.

Accessing Network Drives: Modern operating systems and network setups allow interconnected devices to share resources like files and printers. Once the ransomware identifies these network shares, it can access them just as the infected user's account can. If the user has read/write access to a network share, so does the ransomware.

Encryption of Network Files: The ransomware starts encrypting files on these network shares. Encryption is often done using strong cryptographic algorithms, making it nearly impossible to decrypt the files without the specific key held by the attackers. This process can happen very quickly, depending on the speed of the network and the computing power of the infected endpoint.

Propagation Mechanisms: Some ransomware variants can also propagate themselves across the network. They may exploit vulnerabilities on other machines within the network or use the initial infected endpoint as a launchpad to deliver the payload to other connected systems.

Lack of Segmentation and Access Controls: In many network environments, there is a lack of proper segmentation and access control. This means once inside the network, the ransomware can easily find and encrypt files across different systems and network shares.

To protect data from malicious activity on available network drives, systems currently use two methods: 1) Backing up data and then restoring it from backup copies. However, if the server with backup copies becomes infected, recovery will be impossible. 2) Write protection. However, in this case, the ability to change data is lost.

Ransomware detection programs generally use the following methods: 1) Signature-based detection: This is one of the most common methods in which the antivirus uses a signature database that contains the characteristics of known malware, including ransomware. The antivirus scans files and compares them with signatures to identify matches. If a match is found, the file is considered malicious and may be quarantined or deleted. 2) Behavioral detection: Antiviruses can monitor the behavior of programs in real time. If a program begins to act in an unusual way, such as encrypting the user's files without the user's permission, the antivirus may consider this suspicious and take action to block the program's actions. 3) Heuristic analysis: This method allows antiviruses to detect new or unknown malware based on anomalous or suspicious patterns in the program's behavior or code. This helps antiviruses recognize ransomware that could otherwise avoid detection by signatures. 4) Anomaly detection: Antiviruses can analyze the system for anomalies, such as unexpected changes to files or the registry, to identify signs of ransomware. 5) Real-time protection: Antivirus programs can work in real time, scanning all newly created and modified files and processes for threats. This allows quick response to ransomware before the ransomware has time to cause harm. 6) Exploit Protection: Antiviruses can detect and block attempts to exploit known vulnerabilities in operating systems or applications that can use ransomware to inject themselves into the system.

Since the attacking program is located on another computer and only changes data on another computer, in this case it is not possible to use the detection methods described above. These prior methods have at least three disadvantages: a) if even only one endpoint became infected, malicious actors can still encrypt all network shares; b.) a false detection of valid and legal programs, which would need whitelisting by an administrator; and c.) a lack of detection of malicious activity. In some cases, it will be impossible to detect file encryption at an early stage. There is a need to overcome these shortcomings and disadvantages in the cybersecurity field.

### SUMMARY OF THE INVENTION

The present invention is part of an endpoint security product system. The invention described here is added to provide additional layer of protection for endpoint security users. This present invention provides security and protection for end users. The present invention includes a method of preventing ransomware which includes the steps of buffering data into memory and preventing writing to a disk and then sending the data for verification in user mode through a system service to an antivirus engine crypto-locker scanner. The invention then makes a verdict by the anti-virus engine if encryption is present and records the data if encryption is not detected. The invention blocks the recordation of the data if encryption is detected in the data, and localizes the data to prevent encryption spreading across a network.

### BRIEF DESCRIPTION OF DRAWINGS

FIG. 1 is an illustration of a ransomware threat to a network.

FIG. 2 is an illustration of the present invention in endpoint security.

FIG. 3 is an illustration of the processors, memory, and storage devices within a computing device.

FIG. 4 is a schematic of an individual user operating a computer or handheld device which is connected to the internet.

FIG. 5 is a schematic of the method of the present invention.

### DETAILED DESCRIPTION OF THE INVENTION

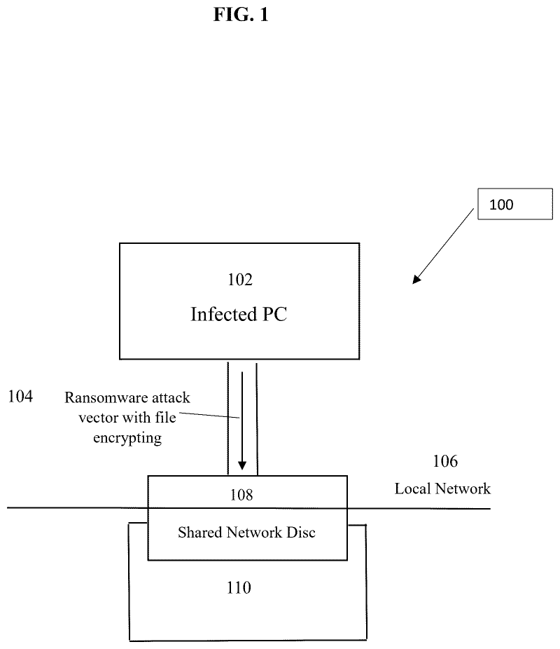

The present invention allows protection of data (documents, media, databases) located on network drives on a local network from ransomware programs. This present invention protects an organization or user's data on network shares even if only one endpoint is protected using this method. Otherwise, organizations are forced to cover 100% of their endpoints with proper endpoint protection solutions. This can be useful for organizations that have a large local network and use it to exchange data. The image in FIG. 1 is the present invention 100 which shows a threat by a ransomware attack 104 on a network 106. There is shown an infected device 102 and the ransomware attack vector 104 with file encrypting capabilities which originates from the single infected PC 102. The ransomware attack 104 hits the local network 106 at the shared network disc 108, but the ransomware attack 104 is prevented from escalating by host device/personal computer 110 with installed client security program of present invention.

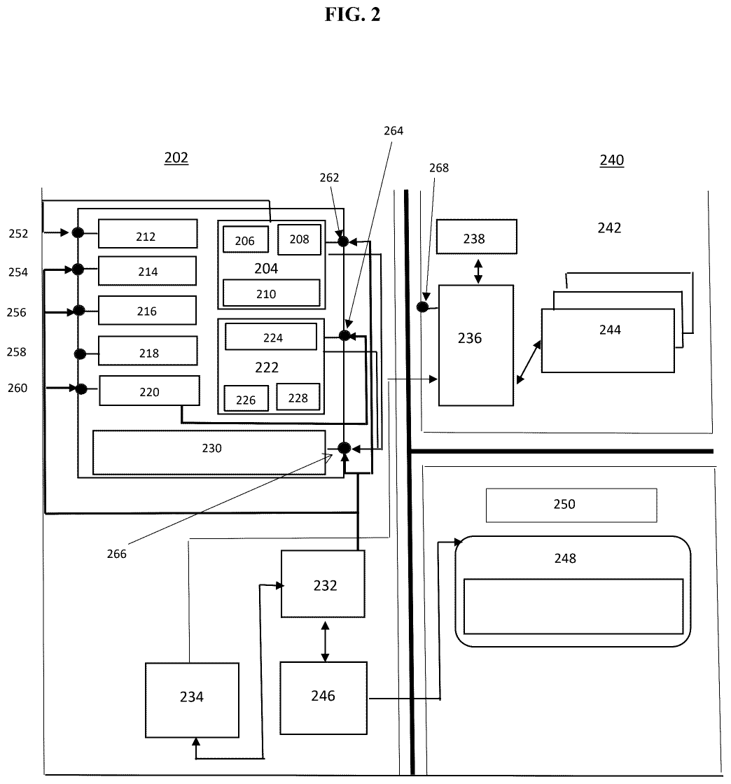

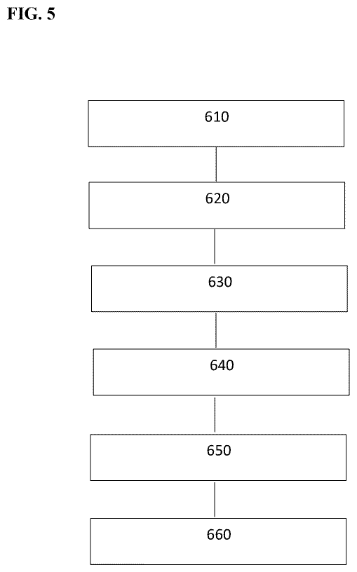

FIG. 2 and FIG. 5 describe a general scheme of the present invention working on an endpoint device with endpoint security, such as Xcitium Client Security. The square (IOCTL Thread) 232 at the bottom of the FIG. 2 shows a kernel service that intercepts Windows disk interrupts. If a file on a shared network drive is written to, then this service buffers the data into memory and does not allow writing to the disk (FIG. 5, step 610). After buffering, it sends this data for verification (Step 620) in user mode through a system service (CavWP) 234 to the antivirus engine cryptolocker scanner 240. The anti-virus engine 240 makes a verdict (Step 630) and if it does not detect encryption, then in this case the data will be recorded (Step 640). If encryption was detected, the recording will be blocked (Step 650). A message about this event will be sent to the admin portal. The administrator is able to localize the threat and block its spread across the network (Step 660).

Detecting data encryption, especially if the encryption method is not known, is not an easy task. However, the method of the present invention ensures a determination that the file was encrypted. This is a file header change. All file types can be identified by their first bytes. Legitimate programs do not change file headers; this behavior is typical for ransomware programs. If the ransomware tries to write data to the beginning of the file, the data being written is buffered and compared with the current data. If the header has changed, this is a signal that the file has been encrypted.

In this manner, the present invention allows for saving data and blocking the spread of malware over a local network.

Referring to FIG. 2., the service provider 202 includes the antivirus center service 204, the trusted center service 222 and the performance booster service 230. The antivirus center service 204 includes a quarantine area 206, pending operations 208, and infected file database 210. The antivirus center service 204 receives input from the ISvcAvCenter node 262 and communicates output to the logging service 212 via the ISvcLogs 252. The antivirus center service 204 also sends output to the performance booster service 230 via ISvcBooster 266.

The trusted center service 222 incudes trusted vendors 224, safe files list and pending files 228. The trusted center service 222 receives input form the iSvcTrustCenter 264 which receives information and communication from config service 220.

The performance booster service 230 includes items such as AV scan, cache, NTFS logs, parser, etc. The performance booster service 230 receives input communication and information from ISvcBooster 266 (which is receiving the output from Antivirus center service 204, trust center service 222. The IOCTL thread 232 also provides information at the ISvcBooster node 266.

Also within the service provider 202 are the logging service 212, the FLS service 214, the Camas service 216, the submit service 218 and the config service 220. The logging service 212 receives information and data, log files from ISvcLogs 252 which is communicated as output from the antivirus service center 204. The FLS service receives information (files, file information, data etc.) that is communicated from ISvcFLS 254. The CAMAS service 216 receives information that is communicated from ISvcCamas 256. The submit service receives information communicated from ISvcSubmit 258. Similarly, the config service 220 receives information communicated from ISvcConfig 260.

The antivirus engine 240 includes the antivirus monitor 236 in communication with the NT-DOS path mapper 238. The antivirus monitor 236 also includes communication with an antivirus scan engine, such as Comodo antivirus scan engine 244. The antivirus scan engine is a pool 242 of antivirus scan engines simple scanners, with thirty two scanners are used in an embodiment, but other numbers of scanners are within the scope. The iAvMonitor node is indicated as 268.

The IOCTL (input/output control system call) thread handle 232 communicates with the service provider 202 at the iSvcBooster node 266 and at iSvcCenter node 262. The IOCTL thread 232 also communicates with the service provider 202 at the FLS service 214 at iSvcFLS node 254. Similarly, the IOCTL thread 232 also communicates with the service provider 202 at the CAMAS service 216 at iSvcCamas node 256 and with the config service 220 at iSvcConfig node 260.

The IOCTL thread 232 communicates with CavWp manager 234 which also communicates information back to the IOCTL thread 232. The CavWp manager 234 communicates to the antivirus engine 240 at the antivirus monitor 236 with a pointer to current antivirus real time working process.

The IOCTL thread handle 232 also communicates with the alert subsystem 246, which in turn communicates alerts to the antivirus alert user interface 248 at the antivirus client 250. The alert subsystem 246 also communicates back to IOCTL thread handle 232.

The antivirus (AV) client 250 includes files such as cfp.exe, antivirus scan, and others. The antivirus client 250 provides an alert system 248 on the user interface. The alert system 248 is receiving information from the alert subsystem 246 which is communicating with the IOCTL thread handle 232.

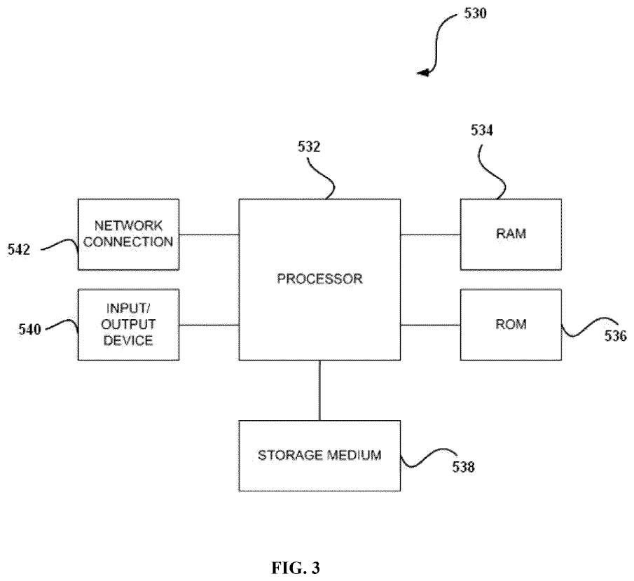

The system and method according to the present invention may be implemented on a computer system or devices, such as tablets or smart phone devices. The present invention may be implemented within a system with which may include substantially any suitable computing device. By way of example, the present invention may generally be implemented within an overall computing network which includes a plurality of computing devices. FIG. 3 illustrates a computing device or individual computer system suitable for implementing the present invention. A computing device or individual computer system 530 includes any number of processors 532 (also referred to as central processing units, or CPUs) that are coupled to memory devices including primary storage devices 534 (typically a random access memory, or RAM) and primary storage devices 536 (typically a read only memory, or ROM). ROM acts to transfer data and instructions uni-directionally to the CPU 532, while RAM is used typically to transfer data and instructions in a bi-directional manner.

CPU 532 may generally include any number of processors. Both primary storage devices 534, 536 may include any suitable computer-readable media. A secondary storage medium 538, which is typically a mass memory device, is also coupled bi-directionally to CPU 532 and provides additional data storage capacity. The mass memory device 538 is a computer-readable medium that may be used to store programs including computer code, data, and the like. Typically, mass memory device 538 is a storage medium such as a hard disk or a tape which is generally slower than primary storage devices 534, 536. Mass memory storage device 538 may take the form of a magnetic or paper tape reader or some other well-known device. It will be appreciated that the information retained within the mass memory device 538, may, in appropriate cases, be incorporated in standard fashion as part of RAM 534 as virtual memory. A specific primary storage device 536 such as a CD-ROM may also pass data uni-directionally to the CPU 532.

CPU 532 is also coupled to one or more input/output devices 540 that may include, but are not limited to, devices such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 532 optionally may be coupled to a computer or telecommunications network, e.g., a local area network, an internet network or an intranet network, using a network connection as shown generally at 542. With such a network connection, it is contemplated that the CPU 532 might receive information from the network, or might output information to the network in the course of performing the above-described method steps. Such information, which is often represented as a sequence of instructions to be executed using CPU 532, may be received from and outputted to the network, for example, in the form of a computer data signal embodied in a carrier wave. The above-described devices and materials will be familiar to those of skill in the computer hardware and software arts.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” or “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “computer readable storage medium” may be any tangible medium (but not a signal medium—which is defined below) that can contain, or store a program. The terms “machine readable medium,” “computer-readable medium,” or “computer readable storage medium” are all non-transitory in their nature and definition. Non-transitory computer readable media comprise all computer-readable media except for a transitory, propagating signal.

The term “machine-readable signal” refers to any signal used to provide machine instructions and/or data to a programmable processor. A “computer readable signal medium” may be any computer readable medium that is not a computer readable storage medium and that can communicate, propagate, or transport a program.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

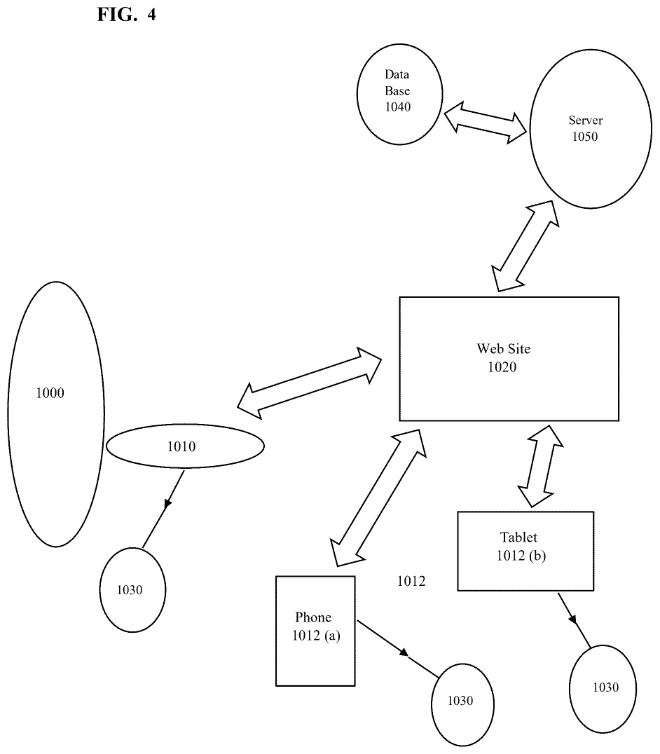

As shown generally by FIG. 4, there is a user 1000 of a computer 1010 or handheld device 1012 who accesses an Internet website 1020 with network connections to a server 1050 and database 1040. The computer 1010 or handheld device is compatible with operating systems known in the art, such as Windows, iOS or android devices or android type operating systems. The user 1000 is potentially exposed to many malicious or unsafe applications located on the web or a particular website 1020 due to lack of security and validation with the source, even though the website 1020 itself may be known as reliable and trusted. The website may be an application store or directory which includes other software applications for downloading. Similarly, receiving email may introduce unsafe internet links, applications and attachments to the user's computer or device. Those of skill in the art would recognize that the computer 1010 or hand held devices 1012a or 1012b each has a processor and a memory coupled with the processor where the memory is configured to provide the processor with executable instructions. A boot disk 1030 is present for initiating an operating system as well for each of the computer 1010 or hand held devices 1012. It should also be noted that as used herein, the term handheld device includes phones, smart phones, tablets, personal digital assistants, media and game players and the like. It should also be understood that the user's computer or device may be part of an internal network or system which is communicating with the Internet. As used throughout the specifications, the term “query” or “queries” is used in the broadest manner to include requests, polls, calls, summons, queries, and like terms known to those of skill in the art.

The invention is not restricted to the details of the foregoing embodiments. The invention extend to any novel one, or any novel combination, of the features disclosed in this specification (including any accompanying claims, abstract and drawings), or to any novel one, or any novel combination, of the steps of any method or process so disclosed.

What is claimed is:

1. A method of preventing ransomware comprising the steps of:
buffering data into memory and preventing writing to a disk;
sending said data for verification in user mode through a system service to an antivirus engine crypto-locker scanner;
making a verdict by said anti-virus engine if encryption is present;
recording said data if encryption is not detected;
blocking recordation of said data if encryption is detected in said data, and;
localizing said data to prevent encryption spreading across a network.
